(19) United States
(12) Patent Application Publication
(10) Pub. No.: US 2024/0345773 A1
(43) Pub. Date: Oct. 17, 2024

(54) PRE-OPERATION FOR APPLICATION TO BOOST FIRMWARE PERFORMANCE

(71) Applicant: Micron Technology, Inc., Boise, ID (US)

(72) Inventors: Zhengbo Wang, Shanghai (CN); Jia Sun, Shanghai (CN)

(21) Appl. No.: 18/626,039

(22) Filed: Apr. 3, 2024

Related U.S. Application Data
(60) Provisional application No. 63/495,814, filed on Apr. 13, 2023.

(51) Int. Cl. G06F 3/06

(52) U.S. Cl. CPC G06F 3/0659; G06F 3/0604; G06F 3/0643; G06F 3/0683

(57) ABSTRACT

Methods, systems, and devices for pre-operation for application to boost firmware performance are described. A host system may notify a memory system of a logical block address range corresponding to an upcoming access operation. The memory system may use the logical block address range to load an associated portion of a logical-to-physical mapping from a non-volatile memory device to a volatile memory device prior to receiving a command to perform the access operation. Accordingly, after the host system issues the command for the memory system to perform the access operation, the memory system may perform the access operation faster as the memory system has already loaded relevant portions of the logical-to-physical mapping associated with the access operation.

### CROSS REFERENCE

The present application for patent claims priority to U.S. Patent Application No. 63/495,814 by Wang et al., entitled “PRE-OPERATION FOR APPLICATION TO BOOST FIRMWARE PERFORMANCE,” filed Apr. 13, 2023, which is assigned to the assignee hereof, and which is expressly incorporated by reference in its entirety herein.

### TECHNICAL FIELD

The following relates to one or more systems for memory, including pre-operation for application to boost firmware performance.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 illustrates an example of a system that supports pre-operation for application to boost firmware performance in accordance with examples as disclosed herein.

FIG. 2 illustrates an example of a system diagram that supports pre-operation for application to boost firmware performance in accordance with examples as disclosed herein.

FIG. 3 illustrates an example of a block descriptor that supports pre-operation for application to boost firmware performance in accordance with examples as disclosed herein.

FIG. 4 illustrates an example of a block descriptor that supports pre-operation for application to boost firmware performance in accordance with examples as disclosed herein.

FIG. 5 illustrates an example of a block descriptor that supports pre-operation for application to boost firmware performance in accordance with examples as disclosed herein.

FIG. 6 illustrates an example of a block descriptor that supports pre-operation for application to boost firmware performance in accordance with examples as disclosed herein.

FIG. 7 illustrates an example of a block descriptor that supports pre-operation for application to boost firmware performance in accordance with examples as disclosed herein.

FIG. 8 illustrates a block diagram of a system that supports pre-operation for application to boost firmware performance in accordance with examples as disclosed herein.

FIG. 9 illustrates a block diagram of a memory system that supports pre-operation for application to boost firmware performance in accordance with examples as disclosed herein.

FIGS. 10 and 11 illustrate flowcharts showing a method or methods that support pre-operation for application to boost firmware performance in accordance with examples as disclosed herein.

### DETAILED DESCRIPTION

In some examples, to perform an access operation, a memory system (e.g., a NAND memory system) may load a logical-to-physical mapping associated with information to be accessed. For example, the memory system may transfer a portion of a logical-to-physical mapping associated with the information to be accessed from a non-volatile memory device of the memory system to a volatile memory device (e.g., an SRAM device) of the memory system. Loading the logical-to-physical mapping may be time consuming, however, and performing the loading after the memory system receives an access command may increase latency associated with an access operation associated with the access command.

In accordance with examples and techniques as described herein, a host system may notify a memory system of a logical block address range corresponding to an upcoming access operation. The memory system may use the logical block address range to load (e.g., pre-load, pre-fetch) an associated portion of a logical-to-physical mapping (e.g., from a non-volatile memory device to a volatile memory device) prior to receiving a command to perform the access operation. Accordingly, after the host system issues the command for the memory system to perform the access operation, the memory system may perform the access operation faster as the memory system has already loaded at least some of the relevant portions of the logical-to-physical mapping associated with the access operation.

In addition to applicability in memory systems as described herein, techniques for pre-operation for application to boost firmware performance may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by facilitating firmware performance, which may decrease processing or latency times, improve response times, or otherwise improve user experience, among other benefits.

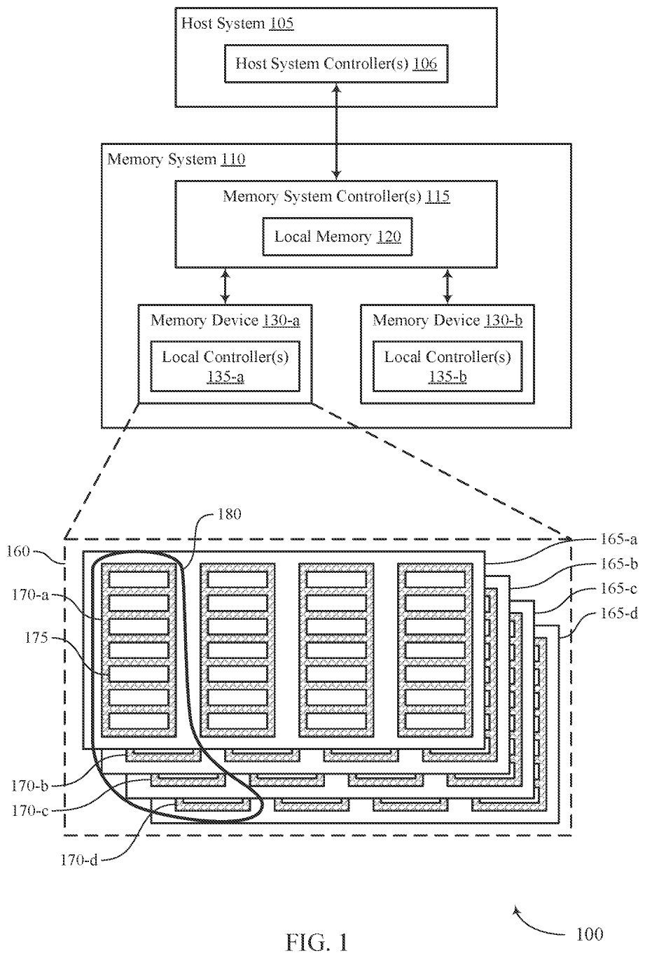

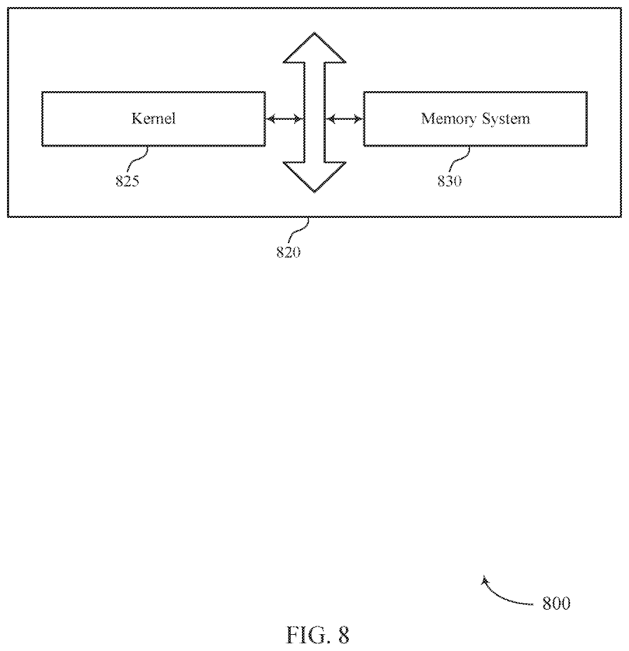

Features of the disclosure are initially described in the context of systems, system diagrams, and block descriptors with reference to FIGS. 1 through 7. These and other features of the disclosure are further illustrated by and described in the context of apparatus diagrams and flowcharts that relate to pre-operation for application to boost firmware performance with reference to FIGS. 8 through 10.

FIG. 1 illustrates an example of a system 100 that supports pre-operation for application to boost firmware performance in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with one or more host system controllers 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), one or more memory controllers (e.g., NVDIMM controller), and one or more storage protocol controllers (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between one or more host system controllers 106 of the host system 105 and one or more memory system controllers 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include one or more memory system controllers 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

One or more memory system controllers 115 may be coupled with and communicate with the host system 105 (e.g., via the physical host interface) and may be an example of a controller or control component configured to cause the memory system 110 to perform various operations in accordance with examples as described herein. One or more memory system controllers 115 may also be coupled with and communicate with memory devices 130 to perform operations such as reading data, writing data, erasing data, or refreshing data at a memory device 130—among other such operations-which may generically be referred to as access operations. In some cases, one or more memory system controllers 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, one or more memory system controllers 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

One or more memory system controllers 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

One or more memory system controllers 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including one or more memory system controllers 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) one or more local controllers 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single crase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support pre-operation for application to boost firmware performance. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

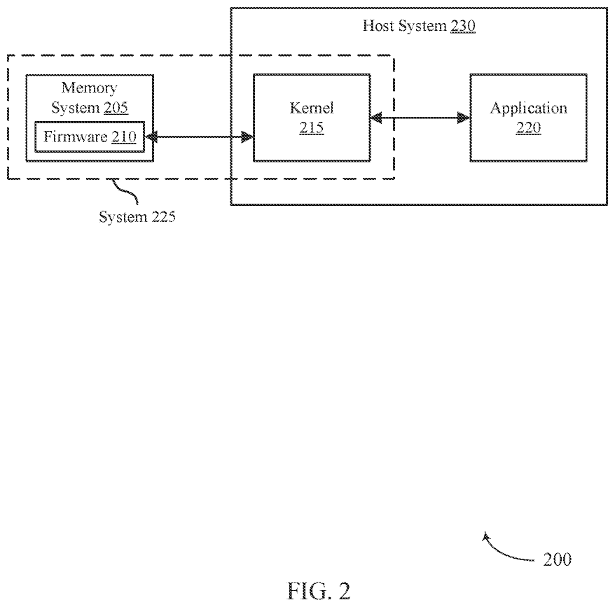

FIG. 2 illustrates an example of a system diagram 200 that supports pre-operation for application to boost firmware performance in accordance with examples as disclosed herein. The system diagram 200 may include a memory system 205, a kernel 215, and an application 220. The memory system 205 may include a firmware 210 and may be an example of the memory system 110 as described herein, with reference to FIG. 1. The firmware 210 may be implemented by one or more controllers and/or other circuitry of the memory system (e.g., one or more memory system controllers 115 and/or one or more local controllers 135). In some examples, a system 225 as described herein may include the memory system 205 and the kernel 215. Additionally, a host system 230 may include the kernel 215 and the application 220 and may be an example of the host system 105 as described herein, with reference to FIG. 1.

The memory system 205 may include multiple memory devices, including non-volatile memory devices and volatile memory devices (e.g., local memory 120), configured to store and retrieve data. The firmware 210 may refer to software stored within a memory array within the memory system 205 (e.g., a non-volatile memory device within the memory system 205) that may provide low-level control functions for the memory system 205. For example, the firmware 210 may function as an interface between the memory system 205 and other components of the system 225, and the host system 230 may issue access operations to the memory system 205 by interfacing with the firmware 210. In some examples, the firmware 210 may be or be included within or implemented by one or more memory system controllers 115, as described herein with reference to FIG. 1. In some examples, the memory system 205 may store a logical-to-physical mapping that maps logical addresses to physical addresses within a non-volatile memory device (e.g., in a logical-to-physical table). To perform a memory access operation, the memory system 205 may move a portion of the logical-to-physical mapping corresponding to one or more logical addresses (e.g., indicated by the kernel 215) from the non-volatile memory device to a volatile memory device.

The kernel 215 may function as an interface between the host system 230 and components associated with the host system 230, such as an operating system of the host system 230. Additionally, the kernel 215 may perform resource allocation and file management, among other operations, for the host system 230. For example, an application 220 running within the host system 230 may access information stored within the memory system 205 by issuing commands to the kernel 215, which may indicate files to be accessed. The kernel 215 may store mapping information associated with the files. For example, a file may be associated with a file name, and may correspond to a range of logical block addresses. The kernel 215 may store mapping information (e.g., a mapping table) that may track logical block addresses corresponding to files of the host system 230. In some examples, the application 220 may issue an access command to the kernel 215 indicating a file name, and offset, and a length associated with a file to be accessed, and the kernel 215 may retrieve a one or more logical block addresses corresponding to the file to be accessed. The kernel 215 may then communicate with the firmware 210 to indicate the one or more logical block addresses to the memory system 205, and the memory system 205 may perform an access operation based on the one or more logical block addresses. The memory system 205 may communicate the accessed information to the kernel 215 (e.g., via the firmware 210).

In some examples, the kernel 215 may communicate with to the firmware 210 using information units (e.g., UFS protocol information units (UPIUs)). For example, the kernel 215 may issue or receive commands, responses, data, or other information via information units exchanged with the firmware 210. An information unit may refer to a data packet that may contain a header segment and one or more transaction specific fields. In some examples, an information unit may additionally include one or more extended header segments, one or more data segments, or a combination thereof. The header segments of an information unit may indicate information associated with a destination for the information unit, a source of the information unit, a function request, whether additional data or parameters are to be transmitted, whether the additional data or parameters are included within the information unit or to be sent in a following information unit, or any combination thereof. The transaction specific fields may be used for additional fields depending on the operation associated with the information unit. The data segments may be used to include data to be transferred from a device to another.

In some examples, a command information unit (e.g., a command UPIU) may be an example of an information unit associated with the transmission of a command (e.g., an SCSI command) and may indicate a device to perform some operation indicated by the command information unit. For example, the command information unit may include a block descriptor (e.g., a command descriptor block) which may indicate information related to the operation indicated by the command information unit. In some examples, the kernel 215 may transfer a command information unit to the memory system 205 to indicate the memory system 205 of an operation to be performed by the memory system 205.

In some examples, to perform an access operation, the memory system 205 may load a logical-to-physical mapping associated with information to be accessed. For example, the memory system 205 may transfer a portion of a logical-to-physical mapping associated with the information to be accessed from a non-volatile memory device of the memory system 205 (e.g., NAND memory) to a volatile memory device (e.g., an SRAM) of the memory system 205. Loading the logical-to-physical mapping may be time consuming, however, and performing the loading after the memory system receives an access operation may increase latency associated with the access operation. For example, the host system 230 may issue an access command to the memory system 205, and there may be a delay associated with loading the logical-to-physical mapping at the memory system 205 prior to the memory system performing the access operation and issuing a response to the host system 230.

In accordance with examples and techniques as described herein, the host system 230 may notify a memory system 205 of a logical block address range corresponding to an upcoming access operation (e.g., prior to issuing an access command). The memory system 205 may use the logical block address range to load (e.g., pre-load, pre-fetch) an associated portion of a logical-to-physical mapping (e.g., from a non-volatile memory device to a volatile memory device) prior to receiving an access command that indicates the memory system 205 to perform the access operation. Accordingly, after the host system 230 issues the access command, the memory system 205 may issue a response to the host system faster as the memory system 205 has already loaded relevant portions of the logical-to-physical mapping associated with the access operation, thereby removing the associated delay.

Techniques described herein may provide functions, methods, and commands that may provide an interface for the application 220 to provide an indication of a file associated with an upcoming access operation to the kernel 215, and for the kernel 215 to obtain one or more logical block addresses associated with the file and provide an indication the one or more logical block addresses to the memory system 205. For example, one or more function calls (e.g., system calls, methods, commands) may be provided for use by the application 220 to communicate with the kernel 215. Additionally, one or more functions, such as input/output (I/O) control functions (e.g., ioctl functions) may be provided (e.g., included in a library) for the kernel 215 to use to communicate with the firmware 210 or to perform associated operations. In some examples, the functions, methods, and commands as described herein may be provided as part of an application programming interface (API) or a software update for a system (e.g., an existing system).

In some examples, a pre-read command (e.g., system call) for the application 220 to notify the system 225 of data that is to be accessed in the future may be provided to the host system 230. For example, the pre-read command may indicate a file associated with an upcoming access operation. The application 220 may input one or more parameters associated with the file as function arguments for the pre-read command. For example, the application 220 may input a file descriptor (e.g., an index associated with opening the file for read/write purposes), an offset (e.g., pointing to a location in the file where a read or write operation may start), a length (e.g., associated with a read or write operation), or a combination thereof, associated with the file, which may allow the kernel 215 to obtain a corresponding logical block address associated with the file. In some examples, the pre-read command may be described according to the following system call descriptor:

SYSCALL_DEFINE(preread,
unsigned int, fd,
unsigned long long, offset,
unsigned long long, len)

In the system call descriptor, fd may refer to the file descriptor associated with the file, offset may correspond to the offset associated with the file, and len may correspond to the length associated with the file. In some examples, these values may be obtained with the use of other system calls (e.g., to open a file for reading or writing, which may return a file descriptor or other parameters).

In some examples, a pre-release command (e.g., system call) for the application 220 to notify the system 225 of data that is ceasing to be accessed (e.g., at least temporarily, for some time period) by the application 220 may be provided to the host system 230. For example, the pre-release command may indicate a file that is ceasing to be accessed by the application 220 (e.g., if the application 220 has finished accessing the file and does not intend to access it again within some time). The application 220 may input one or more parameters associated with the file as function arguments for the pre-release command. For example, the application 220 may input a file descriptor, an offset, a length, or a combination thereof, associated with the file, which may allow the kernel 215 to obtain a corresponding logical block address associated with the file. In some examples, the pre-release command may be described according to the following system call descriptor:

SYSCALL_DEFINE(prerelease,
unsigned int, fd,
unsigned long long, offset,
unsigned long long, len)

In the system call descriptor, fd may refer to the file descriptor associated with the file, offset may correspond to the offset associated with the file, and len may correspond to the length associated with the file. In some examples, these values may be obtained with the use of other system calls (e.g., to open a file for reading or writing, which may return a file descriptor or other parameters).

In some examples, in the context of system call descriptors, the term ‘int’ may indicate that a value is to be provided as an integer value (e.g., a 32-bit integer), long may indicate that a value is to be provided as a long integer value (e.g., a 64-bit integer), and unsigned may indicate that a first bit of a value does not correspond to a sign bit (e.g., resulting in positive values). In some cases, some of the function arguments described in the system call descriptors may be omitted or be considered optional and may, in some cases, not be provided by the application 220.

Accordingly, it may be determined that one or more files are to be accessed in a subsequent access operation (e.g., while a program runs, during a boot sequence, or during other cases). The application 220 may call one or more pre-read commands, indicating parameters associated with the one or more files that are to be accessed in the future. For example, the application 220 may call the one or more pre-read commands at the start of a program, so that access operations corresponding to the files may occur faster at later points while the program is running, which may improve the performance and/or latency.

Additionally, in some examples, the application 220 may determine that one or more files are ceasing to be accessed by a subsequent access operation (e.g., at least temporarily). For example, the application 220 may determine that a file is not to be accessed again (e.g., for some time period) after performing an access operation. The application 220 may call one or more pre-release commands, indicating parameters associated with the one or more files that are ceasing to be accessed. The application 220 may provide information within pre-read commands and pre-release commands to the system 225 (e.g., the kernel 215), which may perform corresponding operations as described herein.

In some examples, the kernel 215 may perform one or more functions in response to pre-read commands and pre-release commands received from the application 220. For example, the kernel 215 may perform a getLba function to obtain a range of logical block addresses associated with a file indicated in a pre-read command or a pre-release command received from the application 220. In some examples, the kernel 215 may input parameters associated with a file as arguments for the getLba function. For example, the kernel 215 may input a filename, an offset, a length, or a combination thereof, associated with the file. The kernel 215 may obtain a range of one or more logical block addresses associated with the file, for example, from a logical block address table maintained by the kernel 215 that maps files (e.g., or information associated with the files) to logical block addresses. In some cases, the getLba function may be described with the following descriptor:
getLba (filename, offset, length)

In this descriptor, filename corresponds to the file name associated with the file, offset corresponds to the offset associated with the file, and length corresponds to the length associated with the file. In some examples, the parameters input as arguments for the getLba function may be determined by the information indicated in a pre-read command or a pre-release command received by the kernel 215 from the application 220, such as a file descriptor, an offset, a length, or a combination thereof, associated with the file.

In some examples, the kernel 215 may perform a sendLba function to send a range of logical block addresses associated with a file indicated in a pre-read command received from the application 220 to the memory system 205. For example, the kernel 215 may provide the firmware 210 with a range of one or more logical block addresses obtained using the getLba function based on a file indicated in a pre-read command from the application 220. In some cases, the getLba function may be described with the following descriptor:
sendLba (LBArangelists)
   In this descriptor, LBArangelists corresponds to a list that indicates the range of one or more logical block addresses associated with a file indicated in a pre-read command. In some examples, the kernel 215 may obtain the list using the getLba command, which may return the list.

In some examples, the kernel 215 may perform a putLba function to send a range of logical block addresses associated with a file indicated in a pre-release command received from the application 220 to the memory system 205. For example, the kernel 215 may provide the firmware 210 with a range of one or more logical block addresses obtained using the getLba function based on a file indicated in a pre-release command from the application 220. In some cases, the getLba function may be described with the following descriptor:
putLba (LBArangelists)

In this descriptor, LBArangelists corresponds to a list that indicates the range of one or more logical block addresses associated with a file indicated in a pre-release command. In some examples, the kernel 215 may obtain the list using the getLba command, which may return the list.

In some examples, the sendLba function and the putLba function may be associated with control functions (e.g., ioctl functions) to provide the firmware 210 with a list of logical block addresses. For example, the kernel 215 may perform a get_lba control function to indicate a list of logical block addresses associated with a pre-read command to the firmware 210. Accordingly, the memory system 205 may perform a pre-read operation by loading (e.g., transferring from a non-volatile memory device to a volatile memory device) the range of logical block addresses. In some examples, performing the sendLba function is associated with calling the get_lba control function. In some cases, the get_lba control function may be described with the following descriptor:
get_lba (lbaRangeLists)
   In this descriptor, IbaRangeLists corresponds to a list that indicates the range of one or more logical block addresses associated with a file indicated in a pre-read command by the application 220. In some examples, the get_lba control function (e.g., ioctl function) may be an example of a pre-read command communicated using an information unit.

Additionally, the kernel 215 may perform a put_lba control function to indicate a list of logical block addresses associated with a pre-release command to the firmware 210. Accordingly, the memory system 205 may perform a pre-release operation by releasing (e.g., transferring from a volatile memory device to a non-volatile memory device) the range of logical block addresses. In some examples, performing the putLba function is associated with calling the put_lba control function. In some cases, the put_lba control function may be described with the following descriptor:
put_lba (lbaRangeLists)
   In this descriptor, IbaRangeLists corresponds to a list that indicates the range of one or more logical block addresses associated with a file indicated in a pre-release command by the application 220. In some examples, the put_lba control function (e.g., ioctl function) may be an example of a pre-release command communicated using an information unit.

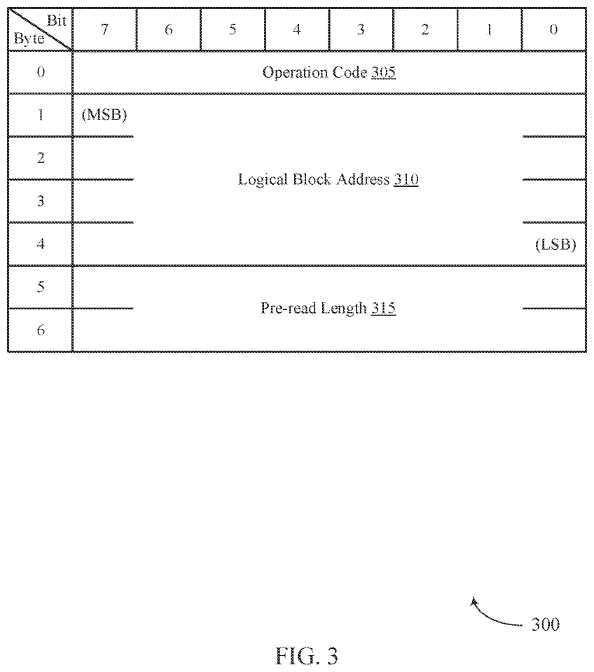

In some examples, in performing the get_lba control function or the put_lba control function, the kernel 215 may transmit an information unit to the firmware 210. For example, the kernel 215 may transmit a command information unit, and fields of the command information unit, such as a descriptor block field, may indicate a type of command (e.g., a pre-read command or a pre-release command) and a range of one or more logical block addresses associated with the command, among other parameters. In some examples, the kernel 215 may transmit multiple information units to the firmware 210, for example, to indicate multiple ranges of one or more logical block addresses. For example, the kernel 215 may transmit a first information unit that indicates a type of command and a length of a second information unit, and subsequently transmit the second information unit that indicates the ranges of one or more logical block addresses. The information to be included within information units (e.g., within a command descriptor block), is described in further detail herein, with reference to FIGS. 3 through 7.

In some cases, the kernel 215 may perform some additional procedures after receiving a pre-read command or a pre-release command from the application 220. For example, after performing a getLba function to obtain a range of one or more logical block addresses associated with a command, the kernel 215 may store an indication of the range of one or more logical block addresses in a list. Then, to perform a get_lba or a put_lba control function, a driver associated with the kernel 215 may retrieve the indication of the range of one or more logical block addresses from the list. The driver may include the information retrieved from the list in an information unit (e.g., a command information unit) alongside information regarding the command (e.g., pre-read command or pre-release command) and send the information unit to the firmware 210. These procedures may be performed at different times and at different rates. For example, the kernel 215 may add multiple ranges of one or more logical block addresses corresponding to multiple commands to the list, and the driver may retrieve the stored ranges from the list as the information units are to be sent. This may allow the kernel 215 to receive multiple pre-read commands and pre-release commands from the application 220 without having to complete all of the procedures associated with a single command before receiving the next command.

Accordingly, it may be determined that a file is to be accessed in a subsequent access operation. The application 220 may call a pre-read command prior to issuing a command to initiate the access operation, and the pre-read command may indicate the file by providing parameters associated with the file to the system 225. In response to the pre-read command, the kernel 215 may perform a getLba function to obtain a range of logical block addresses associated with the file indicated in the pre-read command. The kernel 215 may then perform a sendLba function, which may involve calling a get_lba control function, to pass a list indicating the range of logical block addresses to the firmware 210 using one or more information units. The firmware 210 may cause the memory system 205 to perform the pre-read command, which may include transferring a portion of a logical-to-physical mapping corresponding to the range of logical block addresses from a non-volatile memory device to a volatile memory device. At a later point in time, the application 220 may issue a read command corresponding to the access operation associated with the file. The system 225 may perform the access operation without having to load the logical-to-physical mapping, as this was performed in response to the pre-read command, which may decrease latency associated with the access operation.

In some examples, it may be determined that the file is to cease being used (e.g., in a process or program). The application 220 may call a pre-release command which may indicate the file by providing parameters associated with the file to the system 225. In response to the pre-release command, the kernel 215 may perform a getLba function to obtain a range of logical block addresses associated with the file indicated in the pre-release command. The kernel 215 may then perform a putLba function, which may involve calling a put_lba control function, to pass a list indicating the range of logical block addresses to the firmware 210 using one or more information units. The firmware 210 may cause the memory system 205 to perform the pre-release command, which may involve transferring a portion of a logical-to-physical mapping corresponding to the range of logical block addresses from the volatile memory device to the non-volatile memory device. This may release resources associated with the file, which may allow resources to be used by other processes or operations.

FIG. 3 illustrates an example of a descriptor block 300 that supports pre-operation for application to boost firmware performance in accordance with examples as disclosed herein. The descriptor block 300 may be included within an information unit (e.g., a UPIU) as described herein, with reference to FIG. 2, and may be an example of a command descriptor block. For example, the descriptor block 300 may be included within a descriptor block field (e.g., a command descriptor block field) of a command information unit.

The descriptor block 300 may include information associated with a pre-read command, as described herein with reference to FIG. 2. For example, the descriptor block 300 may be included in an information unit by a host system in response to a pre-read command, and the descriptor block 300 may be transmitted to a memory system as part of a get_lba control function. Accordingly, the descriptor block 300 may include information that may be used by the memory system to perform a pre-read operation. In some examples, the descriptor block 300 may be used to indicate a pre-read command to the memory system in cases where a single logical block address 310 or a single range of logical block addresses is to be pre-read.

In some examples, the descriptor block 300 may include an operation code 305. The operation code 305 may indicate the memory system of an operation to be performed, and may correspond to a pre-read command (e.g., a value of 45 h). In some cases, the operation code 305 may be included within a first byte of the descriptor block 300. The descriptor block 300 may also include the logical block address 310. The logical block address 310 may be obtained by the host system using a getLba function, as described in further detail herein with reference to FIG. 2. In some cases, the logical block address 310 may be included within four bytes of the descriptor block 300. In some examples, the descriptor block 300 may include a pre-read length 315. The length may indicate a length corresponding to the pre-read command, such as a quantity of byes or logical block addresses to be loaded following the logical block address 310 (e.g., the starting logical block address). In some cases, the pre-read length 315 may be included within two bytes of the descriptor block 300.

Accordingly, the host system may issue a pre-read command to the memory system and indicate the memory system of parameters used in performing the pre-read operation. To execute the pre-read operation, the memory system may transfer a portion of a logical-to-physical mapping corresponding to the logical block address 310 and the length 315 from a non-volatile memory device to a volatile memory device.

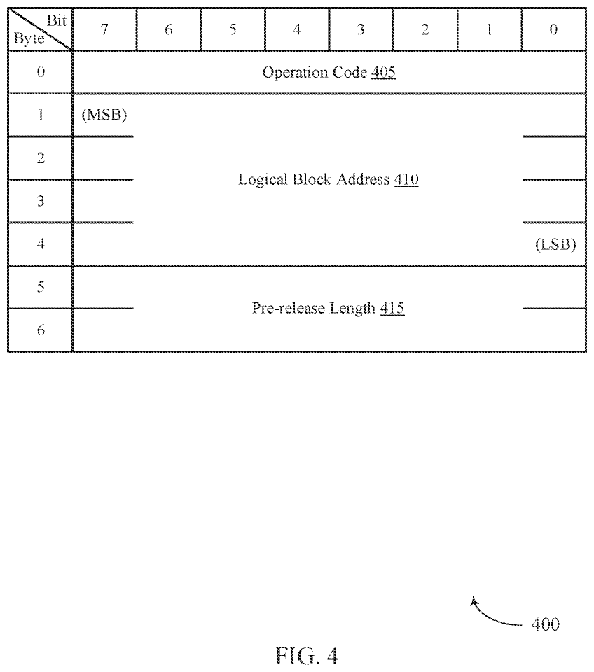

FIG. 4 illustrates an example of a descriptor block 400 that supports pre-operation for application to boost firmware performance in accordance with examples as disclosed herein. The descriptor block 400 may be included within an information unit (e.g., a UPIU) as described herein, with reference to FIG. 2, and may be an example of a command descriptor block. For example, the descriptor block 400 may be included within a descriptor block field (e.g., a command descriptor block field) of a command information unit.

The descriptor block 400 may include information associated with a pre-release command, as described herein with reference to FIG. 2. For example, the descriptor block 400 may be included in an information unit by a host system in response to a pre-release command, and the descriptor block 400 may be transmitted to a memory system as part of a put_lba control function. Accordingly, the descriptor block 400 may include information that may be used by the memory system to perform a pre-release operation. In some examples, the descriptor block 400 may be used to indicate a pre-release command to the memory system in cases where a single logical block address 410 or a single range of logical block addresses is to be indicated pre-released.

In some examples, the descriptor block 400 may include an operation code 405. The operation code 405 may indicate the memory system of an operation to be performed, and may correspond to a pre-release command (e.g., a value of 43 h). In some cases, the operation code 405 may be included within a first byte of the descriptor block 400. The descriptor block 400 may also include the logical block address 410. The logical block address 410 may be obtained by the host system using a getLba function, as described in further detail herein with reference to FIG. 2. In some cases, the logical block address 410 may be included within four bytes of the descriptor block 400. In some examples, the descriptor block 400 may include a pre-release length 415. The length may indicate a length corresponding to the pre-release command, such as a quantity of byes or logical block addresses to be released following the logical block address 410 (e.g., the starting logical block address). In some cases, the pre-release length 415 may be included within two bytes of the descriptor block 400.

Accordingly, the host system may issue a pre-release command to the memory system and indicate the memory system of parameters used in performing the pre-release operation. To execute the pre-release operation, the memory system may transfer a portion of a logical-to-physical mapping corresponding to the logical block address 410 and the length 415 from a volatile memory device to a non-volatile memory device.

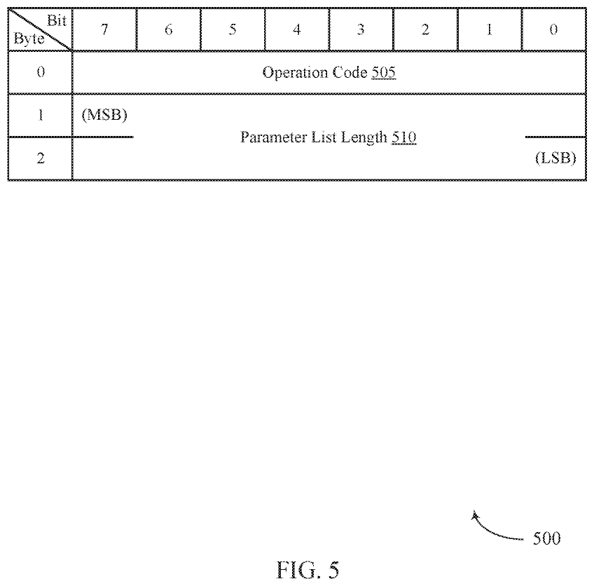

FIG. 5 illustrates an example of a descriptor block 500 that supports pre-operation for application to boost firmware performance in accordance with examples as disclosed herein. The descriptor block 500 may be included within an information unit (e.g., a UPIU) as described herein, with reference to FIG. 2, and may be an example of a command descriptor block. For example, the descriptor block 500 may be included within a descriptor block field (e.g., a command descriptor block field) of a command information unit.

The descriptor block 500 may include information associated with a command, such as a pre-read command or a pre-release command as described herein with reference to FIG. 2. For example, the descriptor block 500 may be included in an information unit by a host system in response to a command, and the descriptor block 500 may be transmitted to a memory system as part of a get_lba or a put_lba control function. Accordingly, the descriptor block 500 may include information that may be used by the memory system to perform a pre-read operation or a pre-release operation. The descriptor block 500 may be used to indicate a multiple pre-read command or a multiple pre-release command, which may correspond to in cases where multiple (e.g., non-consecutive) logical block addresses or multiple ranges of logical block addresses are to be indicated to the memory system for a pre-read operation or a pre-release operation, respectively.

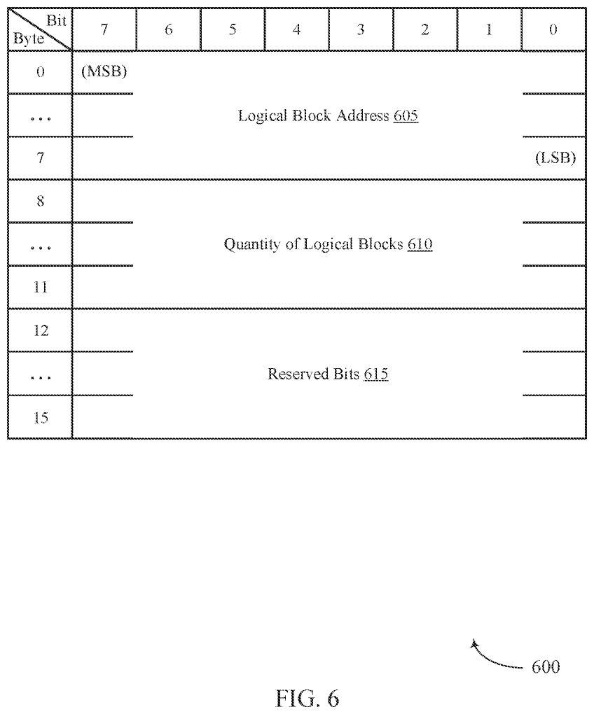

In some examples, the descriptor block 500 may include an operation code 505. The operation code 505 may indicate the memory system of an operation to be performed and may correspond to a multiple pre-read command or a multiple pre-release command (e.g., a value of 44 h). In some cases, the operation code 505 may be included within a first byte of the descriptor block 500. The descriptor block 500 may also include a parameter list length 510. The parameter list length 510 may correspond to the length (e.g., in bytes) of a parameter list that will be transmitted in a subsequent information unit. The parameter list indicates the multiple logical block addresses or multiple ranges of logical block addresses associated with the command and is described in further detail herein, with reference to FIG. 6. In some cases, the parameter list length 510 may be indicated by two bytes of the descriptor block 500. In some cases, the parameter list length 510 indicated by any quantity of bits or bytes of the descriptor block 500 (e.g., 1 byte, 2 bytes, 3 bytes, 4 bytes, 5 bytes, 6 bytes, 7 bytes, 8 bytes, 9 bytes, 10 bytes, 11 bytes, 12 bytes).

FIG. 6 illustrates an example of a descriptor block 600 that supports pre-operation for application to boost firmware performance in accordance with examples as disclosed herein. The descriptor block 600 may be included within an information unit (e.g., a UPIU) as described herein, with reference to FIG. 2, and may be an example of a command descriptor block. For example, the descriptor block 600 may be included within a descriptor block field (e.g., a command descriptor block field) of a command information unit.

The descriptor block 600 may include information associated with a parameter list for a command, such as a multiple pre-read command or a multiple pre-release command as described herein with reference to FIG. 5. For example, a host system may transmit a first information unit including fields associated with the descriptor block 500 to a memory device, as described herein with reference to FIG. 5. Subsequently, the host system may transfer a second information unit that includes fields associated with the parameter list.

The descriptor block 600 be included within the parameter list, and the parameter list may include one or more descriptors blocks 600. Each descriptor block 600 may include a logical block address 605 corresponding to the command. The logical block address 605 may be obtained by the host system using a getLba function, as described in further detail herein with reference to FIG. 2. In some cases, the logical block address 605 may be included within eight bytes of the descriptor block 600. The descriptor block 600 may also specify a quantity of logical blocks 610 that are to be pre-read or pre-released, beginning with the logical block address 605. In some cases, the quantity of logical blocks 610 may be included within four bytes of the descriptor block 600. In some examples, the descriptor block 600 may include reserved bits 615, which may be bits that are not relevant for the command and may be used for other purposes, or not used at all. In some cases, the reserved bits 615 may be included within four bytes of the descriptor block 600.

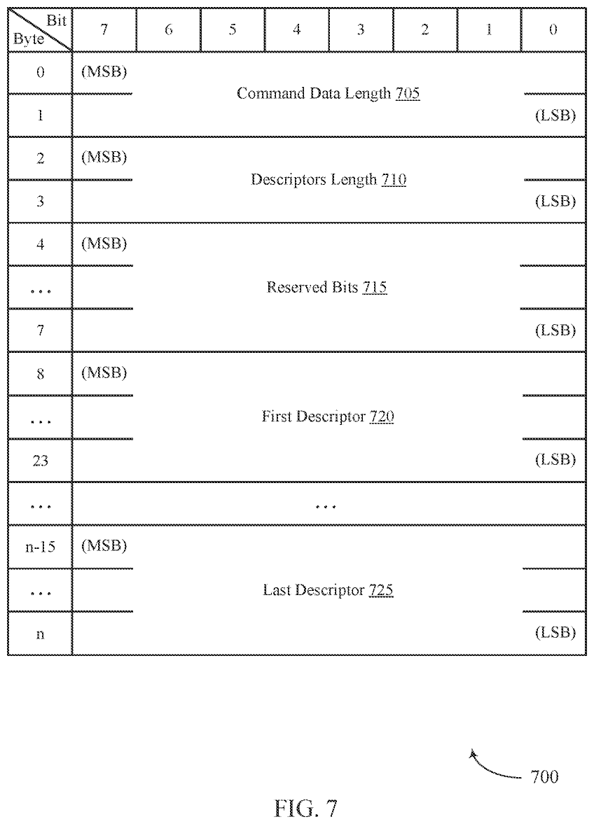

FIG. 7 illustrates an example of a descriptor block 700 that supports pre-operation for application to boost firmware performance in accordance with examples as disclosed herein. The descriptor block 700 may be included within an information unit (e.g., a UPIU) as described herein, with reference to FIG. 2, and may be an example of a command descriptor block. For example, the descriptor block 700 may be included within a descriptor block field (e.g., a command descriptor block field) of a command information unit.

The descriptor block 700 may include information associated with a parameter list for a command, such as a multiple pre-read command or a multiple pre-release command as described herein with reference to FIGS. 5 and 6. For example, a host system may transmit a first information unit to a memory system that may include fields associated with the descriptor block 500, as described herein with reference to FIG. 5. Subsequently, the host system may transfer a second information unit to the memory system that includes fields associated with the descriptor block 700, which represents a parameter list that may include one or more descriptor blocks 600 as described herein, with reference to FIG. 6.

In some examples, the descriptor block 700 may include a command data length 705. The command data length 705 may indicate a length (e.g., in bytes) of data associated with the command that is available to be received by the memory system. In some cases, the command data length 705 may refer to a length of data succeeding the indication of the command data length 705. For example, the command data length 705 may be included in a first two bytes of the descriptor block 700. In these cases, for a descriptor block 700 of length n bytes, the command data length 705 may indicate a quantity of n 2 bytes.

In some examples, the descriptor block 700 may include a descriptors length 710. The descriptors length 710 may indicate a length (e.g., in bytes) associated with the descriptors to be included in the descriptor block 700, such as a first descriptor 720 and a last descriptor 725. In some cases, each descriptor may be associated with a length of 16 bytes. Accordingly, the descriptors length 710 may indicate a length in bytes that may be a multiple of 16 bytes. In some cases, if the indicated length that is not a multiple of 16 bytes, the descriptors length 710 may indicate the memory system that the last descriptor 725 is incomplete. In these cases, the memory system may ignore the last descriptor 725. In some examples, the descriptor block 700 may include reserved bits 715, which may be bits that are not relevant for the command and may be used for other purposes, or not used at all. In some cases, the reserved bits 715 may be included within four bytes of the descriptor block 700.

The first descriptor 720 and the last descriptor 725 may be examples of the descriptor block 600, as described herein with reference to FIG. 6. For example, the first descriptor 720 and the last descriptor 725 may each indicate a logical block address associated with the command, and a quantity of logical blocks associated with the logical block address. In some examples, other descriptors may be included between the first descriptor 720 and the last descriptor 725. Alternatively, the last descriptor 725 may be omitted, and only the first descriptor 720 may be included. In some cases, each descriptor may be included within 16 bytes of the descriptor block 700, and the length may be indicated by the descriptors length 710.

Accordingly, the host system may indicate multiple logical block addresses or multiple ranges of logical block addresses associated with a command (e.g., a pre-read command or a pre-release command) to the memory system by transmitting two information units, and the two information units may include fields corresponding to the descriptor block 500 and the descriptor block 700, respectively.

FIG. 8 illustrates a block diagram 800 of a system 820 that supports pre-operation for application to boost firmware performance in accordance with examples as disclosed herein. The system 820 may be an example of aspects of a system as described with reference to FIGS. 1 through 6. The system 820, or various components thereof, may be an example of means for performing various aspects of pre-operation for application to boost firmware performance as described herein. For example, the system 820 may be an example of the system 225, as described herein with reference to FIG. 2. Similarly, the system 820 may include a kernel 825 and a memory system 830, which may be examples of corresponding components as described herein, with reference to FIGS. 1 through 7. Each of these components may communicate, directly or indirectly, with one another (e.g., via one or more buses).

The kernel 825 may be configured as or otherwise support a means for receiving, from an application (e.g., associated with a host system), a first command indicating a first file to be accessed by an access operation. In some examples, the kernel 825 may be configured as or otherwise support a means for identifying one or more logical block addresses associated with the first file based at least in part on receiving the first command. The memory system 830 may be configured as or otherwise support a means for transferring a portion of a logical-to-physical mapping associated with the first file from a non-volatile memory device to a volatile memory device based at least in part on the one or more logical block addresses associated with the first file and the first command. In some examples, the kernel 825 may be configured as or otherwise support a means for receiving a second command to perform the access operation and access the first file after transferring the portion from the non-volatile memory device to the volatile memory device. In some examples, the memory system 830 may be configured as or otherwise support a means for performing the access operation to retrieve information associated with the first file from the non-volatile memory device based at least in part on receiving the second command.

In some examples, the first command indicates a file name, an offset, a length, or a combination thereof, associated with the first file. In some examples, the kernel 825 may be configured as or otherwise support a means for retrieving the one or more logical block addresses associated with the first file based on the file name, offset, length, or combination thereof, associated with the first file, where identifying the one or more logical block addresses associated with the first file is based at least in part on the retrieving.

In some examples, the kernel 825 may be configured as or otherwise support a means for transferring, to the memory system, a first information unit associated with the first command based at least in part on identifying the one or more logical block addresses, where transferring the portion of the logical-to-physical mapping associated with the first file is based at least in part on transferring the first information unit associated with the first command.

In some examples, the first information unit includes an operation code associated with a pre-read command, an indication of the one or more logical block addresses associated with the first file, and a length value associated with the first command. In some examples, the first information unit includes an operation code associated with a pre-read command and a first value associated with a length of a list, and the kernel 825 may be configured as or otherwise support a means for transferring, to the memory system, a second information unit associated with the first command, the second information unit including a portion of the list that indicates the one or more logical block addresses associated with the first file.

In some examples, the second information unit comprises a second value corresponding to a length of the second information unit, a third value corresponding to a length of each of one or more descriptor blocks, and an indication of the one or more descriptor blocks, where the one or more descriptor blocks indicate the one or more logical block addresses associated with the first file.

In some examples, the kernel 825 may be configured as or otherwise support a means for receiving, from the application (e.g., associated with the host system), a third command indicating a second file that is ceasing to be accessed by the application during a time period. In some examples, the kernel 825 may be configured as or otherwise support a means for identifying one or more logical block addresses associated with the second file based at least in part on receiving the third command.

In some examples, the memory system 830 may be configured as or otherwise support a means for transferring a portion of a logical-to-physical mapping associated with the second file from the volatile memory device to the non-volatile memory device based at least in part on the one or more logical block addresses associated with the second file and the third command.

In some examples, the kernel 825 may be configured as or otherwise support a means for transferring, to the memory system, an information unit associated with the third command, where transferring the portion of the logical-to-physical mapping associated with the second file is based at least in part on transferring the information unit associated with the third command.

In some examples, the kernel 825 may be configured as or otherwise support a means for storing an indication of the one or more logical block addresses associated with the first file, and may be configured as or otherwise support a means for retrieving the indication of the one or more logical block addresses associated with the first file. In some examples, to perform the access operation, the memory system 830 may be configured as or otherwise support a means for retrieving the information associated with the first file from the non-volatile memory device based at least in part on the kernel 825 retrieving the indication of the one or more logical block addresses associated with the first file.

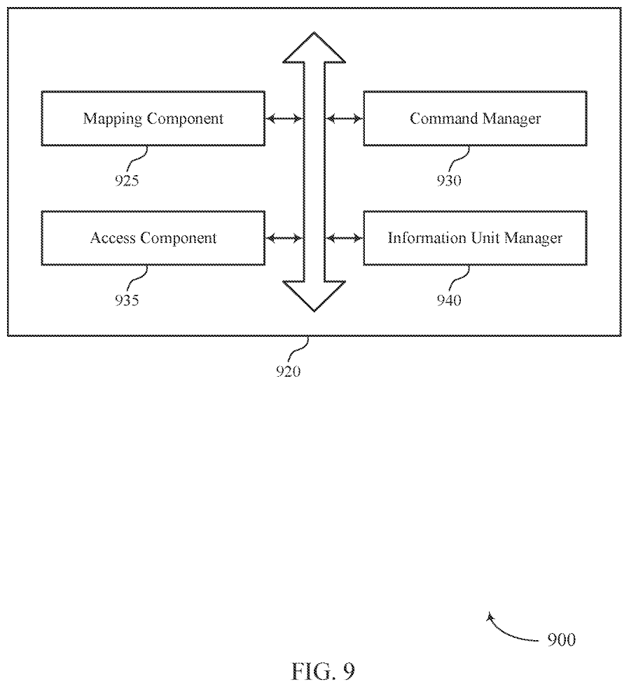

FIG. 9 illustrates a block diagram 900 of a memory system 920 that supports pre-operation for application to boost firmware performance in accordance with examples as disclosed herein. The memory system 920 may be an example of aspects of a memory system as described with reference to FIGS. 1 through 7. The memory system 920, or various components thereof, may be an example of means for performing various aspects of pre-operation for application to boost firmware performance as described herein. For example, the memory system 920 may include a mapping component 925, a command manager 930, an access component 935, an information unit manager 940, or any combination thereof. Each of these components may communicate, directly or indirectly, with one another (e.g., via one or more buses).

The mapping component 925 may be configured as or otherwise support a means for transferring, by a memory system, a portion of a logical-to-physical mapping associated with a first file from a non-volatile memory device to a volatile memory device, the first file to be accessed by an access operation. The command manager 930 may be configured as or otherwise support a means for receiving a command to perform the access operation and access the first file after transferring the portion from the non-volatile memory device to the volatile memory device. The access component 935 may be configured as or otherwise support a means for performing the access operation to retrieve information associated with the first file from the non-volatile memory device based at least in part on receiving the command.

In some examples, the information unit manager 940 may be configured as or otherwise support a means for receiving a first information unit associated with the first file, where transferring the portion of the logical-to-physical mapping associated with the first file is based at least in part on receiving the first information unit.

In some examples, the first information unit includes an operation code associated with a pre-read command, an indication of one or more logical block addresses associated with the first file, and a length value associated with the first file.

In some examples, the first information unit includes an operation code associated with a pre-read command and a first value associated with a length of a list, and the information unit manager 940 may be configured as or otherwise support a means for receiving a second information unit associated with the first file, the second information unit including the list that indicates the one or more logical block addresses associated with the first file.

In some examples, to support second information unit associated with the first file, the information unit manager 940 may be configured as or otherwise support a means for a second value corresponding to a length of the second information unit associated with the first file. In some examples, to support second information unit associated with the first file, the information unit manager 940 may be configured as or otherwise support a means for a third value corresponding to a length of each of one or more first descriptor blocks. In some examples, to support second information unit associated with the first file, the information unit manager 940 may be configured as or otherwise support a means for an indication of the one or more first descriptor blocks, where the one or more first descriptor blocks indicate the one or more logical block addresses associated with the first file.

In some examples, the mapping component 925 may be configured as or otherwise support a means for transferring a portion of the logical-to-physical mapping associated with a second file from the volatile memory device to the non-volatile memory device.

In some examples, the information unit manager 940 may be configured as or otherwise support a means for receiving a first information unit associated with the second file, where transferring the portion of the logical-to-physical mapping associated with the second file is based at least in part on transferring the first information unit.

In some examples, the first information unit includes an operation code associated with a pre-read command and a first value associated with a length of a list that indicates one or more logical block addresses associated with the second file, and the information unit manager 940 may be configured as or otherwise support a means for receiving a second information unit including the list that indicates the one or more logical block addresses associated with the second file.

In some examples, to support second information unit associated with the first file, the information unit manager 940 may be configured as or otherwise support a means for a second value corresponding to a length of the second information unit. In some examples, to support second information unit associated with the first file, the information unit manager 940 may be configured as or otherwise support a means for a third value corresponding to a length of each of one or more second descriptor blocks. In some examples, to support second information unit associated with the first file, the information unit manager 940 may be configured as or otherwise support a means for an indication of the one or more second descriptor blocks, where the one or more second descriptor blocks indicate the one or more logical block addresses associated with the second file.

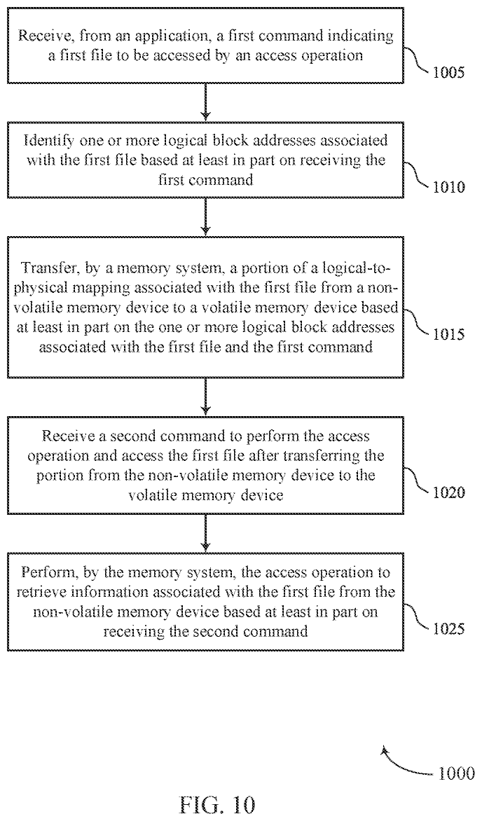

FIG. 10 illustrates a flowchart showing a method 1000 that supports pre-operation for application to boost firmware performance in accordance with examples as disclosed herein. The operations of method 1000 may be implemented by a system or its components as described herein. For example, the operations of method 1000 may be performed by a system as described with reference to FIGS. 1 through 8. In some examples, a system may execute a set of instructions to control the functional elements of the device to perform the described functions. Additionally, or alternatively, the system may perform aspects of the described functions using special-purpose hardware.

At 1005, the method may include receiving, from an application, a first command indicating a first file to be accessed by an access operation. The operations of 1005 may be performed in accordance with examples as disclosed herein. In some examples, aspects of the operations of 1005 may be performed by a kernel 825 as described with reference to FIG. 8.

At 1010, the method may include identifying one or more logical block addresses associated with the first file based at least in part on receiving the first command. The operations of 1010 may be performed in accordance with examples as disclosed herein. In some examples, aspects of the operations of 1010 may be performed by a kernel 825 as described with reference to FIG. 8.

At 1015, the method may include transferring a portion of a logical-to-physical mapping associated with the first file from a non-volatile memory device to a volatile memory device based at least in part on the one or more logical block addresses associated with the first file and the first command. The operations of 1015 may be performed in accordance with examples as disclosed herein. In some examples, aspects of the operations of 1015 may be performed by a memory system 830 as described with reference to FIG. 8.

At 1020, the method may include receiving a second command to perform the access operation and access the first file after transferring the portion from the non-volatile memory device to the volatile memory device. The operations of 1020 may be performed in accordance with examples as disclosed herein. In some examples, aspects of the operations of 1020 may be performed by a kernel 825 as described with reference to FIG. 8.

At 1025, the method may include performing the access operation to retrieve information associated with the first file from the non-volatile memory device based at least in part on receiving the second command. The operations of 1025 may be performed in accordance with examples as disclosed herein. In some examples, aspects of the operations of 1025 may be performed by a memory system 830 as described with reference to FIG. 8.

In some examples, an apparatus as described herein may perform a method or methods, such as the method 1000. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, from an application, a first command indicating a first file to be accessed by an access operation; identifying one or more logical block addresses associated with the first file based at least in part on receiving the first command; transferring, by a memory system, a portion of a logical-to-physical mapping associated with the first file from a non-volatile memory device to a volatile memory device based at least in part on the one or more logical block addresses associated with the first file and the first command; receiving a second command to perform the access operation and access the first file after transferring the portion from the non-volatile memory device to the volatile memory device; and performing, by the memory system, the access operation to retrieve information associated with the first file from the non-volatile memory device based at least in part on receiving the second command.

Aspect 2: The method, apparatus, or non-transitory computer-readable medium of aspect 1, where the first command indicates a file name, an offset, a length, or a combination thereof, associated with the first file.

Aspect 3: The method, apparatus, or non-transitory computer-readable medium of aspect 2, further including operations, features, circuitry, logic, means, or instructions, or any combination thereof for retrieving the one or more logical block addresses associated with the first file based on the file name, offset, length, or combination thereof, associated with the first file, where identifying the one or more logical block addresses associated with the first file is based at least in part on the retrieving.

Aspect 4: The method, apparatus, or non-transitory computer-readable medium of any of aspects 1 through 3, further including operations, features, circuitry, logic, means, or instructions, or any combination thereof for transferring, to the memory system, a first information unit associated with the first command based at least in part on identifying the one or more logical block addresses, where transferring the portion of the logical-to-physical mapping associated with the first file is based at least in part on transferring the first information unit associated with the first command.

Aspect 5: The method, apparatus, or non-transitory computer-readable medium of aspect 4, where the first information unit includes an operation code associated with a pre-read command, an indication of the one or more logical block addresses associated with the first file, and a length value associated with the first command.

Aspect 6: The method, apparatus, or non-transitory computer-readable medium of any of aspects 4 through 5, where the first information unit includes an operation code associated with a pre-read command and a first value associated with a length of a list and the method, apparatuses, and non-transitory computer-readable medium further includes operations, features, circuitry, logic, means, or instructions, or any combination thereof for transferring, to the memory system, a second information unit associated with the first command, the second information unit including a portion of the list that indicates the one or more logical block addresses associated with the first file.

Aspect 7: The method, apparatus, or non-transitory computer-readable medium of aspect 6, where the second information unit associated with the first command includes operations, features, circuitry, logic, means, or instructions, or any combination thereof for a second value corresponding to a length of the second information unit; a third value corresponding to a length of each of one or more descriptor blocks; and an indication of the one or more descriptor blocks, where the one or more descriptor blocks indicate the one or more logical block addresses associated with the first file.

Aspect 8: The method, apparatus, or non-transitory computer-readable medium of any of aspects 1 through 7, further including operations, features, circuitry, logic, means, or instructions, or any combination thereof for receiving, from the application, a third command indicating a second file that is ceasing to be accessed by the application during a time period and identifying one or more logical block addresses associated with the second file based at least in part on receiving the third command.

Aspect 9: The method, apparatus, or non-transitory computer-readable medium of aspect 8, further including operations, features, circuitry, logic, means, or instructions, or any combination thereof for transferring, by the memory system, a portion of a logical-to-physical mapping associated with the second file from the volatile memory device to the non-volatile memory device based at least in part on the one or more logical block addresses associated with the second file and the third command.

Aspect 10: The method, apparatus, or non-transitory computer-readable medium of aspect 9, further including operations, features, circuitry, logic, means, or instructions, or any combination thereof for transferring, to the memory system, a first information unit associated with the third command, where transferring the portion of the logical-to-physical mapping associated with the second file is based at least in part on transferring the first information unit associated with the third command.

Aspect 11: The method, apparatus, or non-transitory computer-readable medium of any of aspects 1 through 10, further including operations, features, circuitry, logic, means, or instructions, or any combination thereof for storing an indication of the one or more logical block addresses associated with the first file, and retrieving the indication of the one or more logical block addresses associated with the first file, where performing the access operation includes: retrieving the information associated with the first file from the non-volatile memory device based at least in part on retrieving the indication of the one or more logical block addresses associated with the first file.

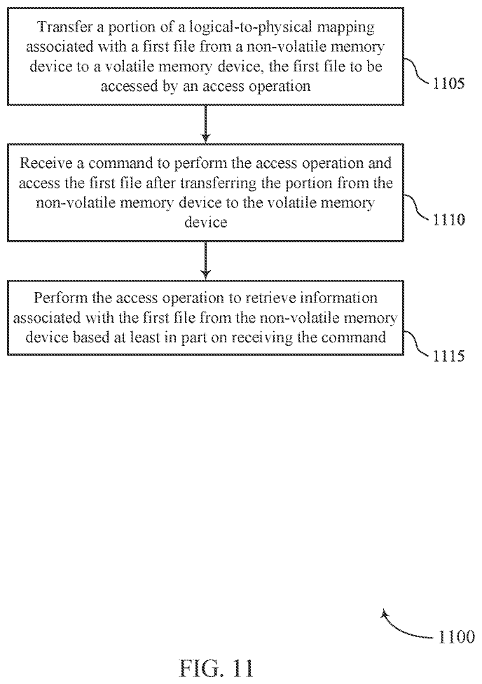

FIG. 11 illustrates a flowchart showing a method 1100 that supports pre-operation for application to boost firmware performance in accordance with examples as disclosed herein. The operations of method 1100 may be implemented by a memory system or its components as described herein. For example, the operations of method 1100 may be performed by a memory system as described with reference to FIGS. 1 through 6 and 9. In some examples, a memory system may execute a set of instructions to control the functional elements of the device to perform the described functions. Additionally, or alternatively, the memory system may perform aspects of the described functions using special-purpose hardware.

At 1105, the method may include transferring, by a memory system, a portion of a logical-to-physical mapping associated with a first file from a non-volatile memory device to a volatile memory device, the first file to be accessed by an access operation. The operations of 1105 may be performed in accordance with examples as disclosed herein. In some examples, aspects of the operations of 1105 may be performed by a mapping component 925 as described with reference to FIG. 9.

At 1110, the method may include receiving a command to perform the access operation and access the first file after transferring the portion from the non-volatile memory device to the volatile memory device. The operations of 1110 may be performed in accordance with examples as disclosed herein. In some examples, aspects of the operations of 1110 may be performed by a command manager 930 as described with reference to FIG. 9.

At 1115, the method may include performing the access operation to retrieve information associated with the first file from the non-volatile memory device based at least in part on receiving the command. The operations of 1115 may be performed in accordance with examples as disclosed herein. In some examples, aspects of the operations of 1115 may be performed by an access component 935 as described with reference to FIG. 9.

In some examples, an apparatus as described herein may perform a method or methods, such as the method 1100. The apparatus may include features, circuitry, logic, means, or instructions (e.g., a non-transitory computer-readable medium storing instructions executable by a processor), or any combination thereof for performing the following aspects of the present disclosure:

Aspect 12: A method, apparatus, or non-transitory computer-readable medium including operations, features, circuitry, logic, means, or instructions, or any combination thereof for transferring a portion of a logical-to-physical mapping associated with a first file from a non-volatile memory device to a volatile memory device, the first file to be accessed by an access operation; receiving a command to perform the access operation and access the first file after transferring the portion from the non-volatile memory device to the volatile memory device; and performing the access operation to retrieve information associated with the first file from the non-volatile memory device based at least in part on receiving the command.

Aspect 13: The method, apparatus, or non-transitory computer-readable medium of aspect 12, further including operations, features, circuitry, logic, means, or instructions, or any combination thereof for receiving a first information unit associated with the first file, where transferring the portion of the logical-to-physical mapping associated with the first file is based at least in part on receiving the first information unit.

Aspect 14: The method, apparatus, or non-transitory computer-readable medium of aspect 13, where the first information unit includes an operation code associated with a pre-read command, an indication of one or more logical block addresses associated with the first file, and a length value associated with the first file.

Aspect 15: The method, apparatus, or non-transitory computer-readable medium of any of aspects 13 through 14, where the first information unit includes an operation code associated with a pre-read command and a first value associated with a length of a list and the method, apparatuses, and non-transitory computer-readable medium further includes operations, features, circuitry, logic, means, or instructions, or any combination thereof for receiving a second information unit associated with the first file, the second information unit including the list that indicates the one or more logical block addresses associated with the first file.

Aspect 16: The method, apparatus, or non-transitory computer-readable medium of aspect 15, where the second information unit associated with the first file includes operations, features, circuitry, logic, means, or instructions, or any combination thereof for a second value corresponding to a length of the second information unit associated with the first file; a third value corresponding to a length of each of one or more first descriptor blocks; and an indication of the one or more first descriptor blocks, where the one or more first descriptor blocks indicate the one or more logical block addresses associated with the first file.

Aspect 17: The method, apparatus, or non-transitory computer-readable medium of any of aspects 12 through 16, further including operations, features, circuitry, logic, means, or instructions, or any combination thereof for transferring a portion of the logical-to-physical mapping associated with a second file from the volatile memory device to the non-volatile memory device.

Aspect 18: The method, apparatus, or non-transitory computer-readable medium of aspect 17, further including operations, features, circuitry, logic, means, or instructions, or any combination thereof for receiving a first information unit associated with the second file, where transferring the portion of the logical-to-physical mapping associated with the second file is based at least in part on transferring the first information unit.

Aspect 19: The method, apparatus, or non-transitory computer-readable medium of aspect 18, where the first information unit includes an operation code associated with a pre-read command and a first value associated with a length of a list that indicates one or more logical block addresses associated with the second file and the method, apparatuses, and non-transitory computer-readable medium further includes operations, features, circuitry, logic, means, or instructions, or any combination thereof for receiving a second information unit including the list that indicates the one or more logical block addresses associated with the second file.

Aspect 20: The method, apparatus, or non-transitory computer-readable medium of aspect 19, where the second information unit associated with the first file includes operations, features, circuitry, logic, means, or instructions, or any combination thereof for a second value corresponding to a length of the second information unit; a third value corresponding to a length of each of one or more second descriptor blocks; and an indication of the one or more second descriptor blocks, where the one or more second descriptor blocks indicate the one or more logical block addresses associated with the second file.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a memory system comprising a volatile memory device and a non-volatile memory device; and
a kernel associated with the memory system, wherein the kernel is configured to cause the apparatus to:
receive, from an application, a first command indicating a first file to be accessed by an access operation; and
identify one or more logical block addresses associated with the first file based at least in part on receiving the first command;
the memory system configured to cause the apparatus to:
transfer, by the memory system, a portion of a logical-to-physical mapping associated with the first file from a non-volatile memory device to a volatile memory device based at least in part on the one or more logical block addresses associated with the first file and the first command;
the kernel configured to cause the apparatus to:
receive a second command to perform the access operation and access the first file after transferring the portion from the non-volatile memory device to the volatile memory device; and
the memory system configured to cause the apparatus to:
perform, by the memory system, the access operation to retrieve information associated with the first file from the non-volatile memory device based at least in part on receiving the second command.

2. The apparatus of claim 1, wherein the first command indicates a file name, an offset, a length, or a combination thereof, associated with the first file.

3. The apparatus of claim 2, wherein the kernel is further configured to cause the apparatus to:
retrieve the one or more logical block addresses associated with the first file based on the file name, offset, length, or combination thereof, associated with the first file, wherein identifying the one or more logical block addresses associated with the first file is based at least in part on the retrieving.

4. The apparatus of claim 1, wherein the kernel is further configured to cause the apparatus to:
transfer, to the memory system, a first information unit associated with the first command based at least in part on identifying the one or more logical block addresses, wherein transferring the portion of the logical-to-physical mapping associated with the first file is based at least in part on transferring the first information unit associated with the first command.

5. The apparatus of claim 4, wherein the first information unit comprises an operation code associated with a pre-read command, an indication of the one or more logical block addresses associated with the first file, and a length value associated with the first command.

6. The apparatus of claim 4, wherein the first information unit comprises an operation code associated with a pre-read command and a first value associated with a length of a list, and the kernel is further configured to cause the apparatus to:
transfer, to the memory system, a second information unit associated with the first command, the second information unit comprising a portion of the list that indicates the one or more logical block addresses associated with the first file.

7. The apparatus of claim 6, wherein the second information unit associated with the first command comprises:
a second value corresponding to a length of the second information unit;
a third value correspond to a length of each of one or more descriptor blocks; and
an indication of the one or more descriptor blocks, wherein the one or more descriptor blocks indicate the one or more logical block addresses associated with the first file.

8. The apparatus of claim 1, wherein the kernel is further configured to cause the apparatus to:
receive, from the application, a third command indicating a second file that is ceasing to be accessed by the application during a time period; and
identify one or more logical block addresses associated with the second file based at least in part on receiving the third command.

9. The apparatus of claim 8, wherein the memory system is further configured to cause the apparatus to:
transfer, by the memory system, a portion of a logical-to-physical mapping associated with the second file from the volatile memory device to the non-volatile memory device based at least in part on the one or more logical block addresses associated with the second file and the third command.

10. The apparatus of claim 9, wherein the kernel is further configured to cause the apparatus to:
transfer, to the memory system, a first information unit associated with the third command, wherein transferring the portion of the logical-to-physical mapping associated with the second file is based at least in part on transferring the first information unit associated with the third command.

11. The apparatus of claim 1, wherein the kernel is further configured to cause the apparatus to:
store an indication of the one or more logical block addresses associated with the first file; and
retrieve the indication of the one or more logical block addresses associated with the first file, wherein, to perform the access operation, the memory system is further configured to cause the apparatus to:
retrieve the information associated with the first file from the non-volatile memory device based at least in part on retrieving the indication of the one or more logical block addresses associated with the first file.

12. An apparatus, comprising:
a memory device; and
one or more controllers associated with the memory device, wherein the one or more controllers are configured to cause the apparatus to:
transfer a portion of a logical-to-physical mapping associated with a first file from a non-volatile memory device to a volatile memory device, the first file to be accessed by an access operation;
receive a command to perform the access operation and access the first file after transferring the portion from the non-volatile memory device to the volatile memory device; and
perform the access operation to retrieve information associated with the first file from the non-volatile memory device based at least in part on receiving the command.

13. The apparatus of claim 12, wherein the one or more controllers are further configured to cause the apparatus to:
receive a first information unit associated with the first file, wherein transferring the portion of the logical-to-physical mapping associated with the first file is based at least in part on receiving the first information unit.

14. The apparatus of claim 13, wherein the first information unit comprises an operation code associated with a pre-read command, an indication of one or more logical block addresses associated with the first file, and a length value associated with the first file.

15. The apparatus of claim 13, wherein the first information unit comprises an operation code associated with a pre-read command and a first value associated with a length of a list, and the one or more controllers are further configured to cause the apparatus to:
receive a second information unit associated with the first file, the second information unit comprising the list that indicates one or more logical block addresses associated with the first file.

16. The apparatus of claim 15, wherein the second information unit associated with the first file comprises:
a second value corresponding to a length of the second information unit associated with the first file;
a third value correspond to a length of each of one or more first descriptor blocks; and
an indication of the one or more first descriptor blocks, wherein the one or more first descriptor blocks indicate the one or more logical block addresses associated with the first file.

17. The apparatus of claim 12, wherein the one or more controllers are further configured to cause the apparatus to:
transfer a portion of the logical-to-physical mapping associated with a second file from the volatile memory device to the non-volatile memory device.

18. The apparatus of claim 17, wherein the one or more controllers are further configured to cause the apparatus to:
receive a first information unit associated with the second file, wherein transferring the portion of the logical-to-physical mapping associated with the second file is based at least in part on transferring the first information unit.

19. The apparatus of claim 18, wherein the first information unit comprises an operation code associated with a pre-read command and a first value associated with a length of a list that indicates one or more logical block addresses associated with the second file, and the one or more controllers are further configured to cause the apparatus to:
receive a second information unit comprising the list that indicates the one or more logical block addresses associated with the second file.

20. A non-transitory computer-readable medium storing code comprising instructions which, when executed by a processor of an electronic device, cause the electronic device to:
receive, from an application, a first command indicating a first file to be accessed by an access operation;
identify one or more logical block addresses associated with the first file based at least in part on receiving the first command;
transfer, by a memory system, a portion of a logical-to-physical mapping associated with the first file from a non-volatile memory device to a volatile memory device based at least in part on the one or more logical block addresses associated with the first file and the first command;
receive a second command to perform the access operation and access the first file after transferring the portion from the non-volatile memory device to the volatile memory device; and
perform, by the memory system, the access operation to retrieve information associated with the first file from the non-volatile memory device based at least in part on receiving the second command.
